(19) United States
(12) Patent Application Publication
(10) Pub. No.: US 2007/0271962 A1
(43) Pub. Date: Nov. 29, 2007

(54) Production method of quartz glass

(75) Inventors: Dai Inoue, Ibaraki (JP); Makoto Yoshida, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: SHIN-ETSU CHEMICAL CO., LTD., Tokyo (JP)

(21) Appl. No.: 11/826,440

(22) Filed: Jul. 16, 2007

Related U.S. Application Data
(63) Continuation of application No. PCT/JP05/23533, filed on Dec. 21, 2005.

(30) Foreign Application Priority Data
Jan. 17, 2005 (JP) 2005-009251

(51) Int. Cl. C03B 37/07; C03B 37/018; G01N 21/00

(52) U.S. Cl. 65/377; 65/414

(57) ABSTRACT

Provided is a manufacturing method of quartz glass, which includes forming a soot deposition member that includes an effective portion having a substantially constant outer diameter and being to become a material of a glass product and ineffective portions formed at both ends of the effective portion and having an outer diameter changing in a tapering form, by depositing soot to a starting member being raised while rotating, the soot being generated by flame hydrolysis of a raw material gas, the manufacturing method either including: an effective portion forming step of forming the effective portion by rotating the starting member and the soot deposition member at a rotation speed appropriate for forming the effective portion, after the stabilization of the outer diameter of the soot deposition member; and an ineffective portion forming step of forming an ineffective portion by setting a peripheral speed of a surface of the starting member to 2.0 m/minute or below, during a time from deposition start of the soot onto the starting member and until the outer diameter of the soot deposition member is stabilized, or including: a forming step of forming an ineffective portion while decreasing a peripheral speed of a surface of the starting member to a predetermined final peripheral speed in a ratio of 1.3 m/minute or below per second during a period after the effective portion is formed and until the starting member and the soot deposition member stop rotating.

### CROSS REFERENCE TO RELATED APPLICATION

This is a continuation application of PCT/JP2005/23533 filed on Dec. 21, 2005 which claims priority from a Japanese Patent Application No. 2005-009251 filed on Jan. 17, 2005, the contents of which are incorporated herein by reference.

### BACKGROUND

1. Technical Field

The present invention relates to a manufacturing method of quarts glass. In particular, the present invention relates to a manufacturing method of quarts glass from which an optical fiber base material is manufactured according to a VAD method.

2. Related Art

One known method of manufacturing an optical fiber base material is a VAD method. In a VAD method, a soot deposition member is manufactured by depositing glass particles to a tip of a starting member attached to a shaft rising while rotating, where the glass particles have been generated by a core deposition burner and a clad deposition burner. The soot deposition member is then subjected to dehydration, sintering, and vitrification into transparent glass, so as to complete a porous optical fiber base material that includes a core layer and a clad layer.

In recent years, the optical fiber base material is becoming larger in size, and the soot deposition member, resulting from deposition of glass particles, is becoming larger in size. In view of this, the rotating speed of the starting member in the VAD method is becoming faster. However, in accordance with the increase in peripheral speed of the surface of the soot deposition member, it sometimes happens that the soot deposition member is removed from the starting member and drops off when stopping the rotation of the soot deposition member after ending of the deposition.

In view of this, there is a demand for a manufacturing method of quarts glass according to which a soot deposition member is prevented from being removed from the started material or dropping off when stopping the rotation of the soot deposition member after ending of a predetermined amount of deposition.

### SUMMARY

In view of the above, it is an advantage of the present invention to provide a manufacturing method of quartz glass, which can solve the foregoing problems. The advantage can be achieved by combinations of features described in the independent claims. The dependent claims define further advantageous concrete examples of the present invention.

Specifically, according to a first embodiment of the present invention, provided is a manufacturing method of quartz glass, which includes forming a soot deposition member that includes an effective portion having a substantially constant outer diameter and being to become a material of a glass product and ineffective portions formed at both ends of the effective portion and having an outer diameter changing in a tapering form, by depositing soot to a starting member being raised while rotating, the soot being generated by flame hydrolysis of a raw material gas, the manufacturing method including: an ineffective portion forming step of forming an ineffective portion by setting a peripheral speed of a surface of the starting member to 2.0 m/minute or below, during a time from deposition start of the soot onto the starting member and until the outer diameter of the soot deposition member is stabilized; and an effective portion forming step of forming the effective portion by rotating the starting member and the soot deposition member at a rotation speed appropriate for forming the effective portion, after the stabilization of the outer diameter of the soot deposition member. According to this, the growth starts after the soot deposition member has firmly attached to the starting member, and so dropping off at the rotation stopping is prevented.

In addition, according to one embodiment, in the manufacturing method of quarts glass, it is preferable that the peripheral speed of the surface of the starting member is set as 1.5 m/minute or below, for the predetermined time from the deposition start. It should be noted that “predetermined time” used here is a time period from the deposition start up to while the ineffective portions of the deposition member are under manufacturing at the longest. According to this, the soot is firmly attached to the starting member.

As a second embodiment of the present invention, provided is a manufacturing method of quartz glass, which includes forming a soot deposition member that includes an effective portion having a substantially constant outer diameter and being to become a material of a glass product and ineffective portions formed at both ends of the effective portion and having an outer diameter changing in a tapering form, by depositing soot to a starting member being raised while rotating, the soot being generated by flame hydrolysis of a raw material gas, the manufacturing method including: a forming step of forming an ineffective portion while decreasing a peripheral speed of a surface of the starting member to a predetermined final peripheral speed in a ratio of 1.3 m/minute or below per second during a period after the effective portion is formed and until the starting member and the soot deposition member stop rotating. According to this, stress from inertia of the soot deposition member per se is alleviated, thereby making it harder for the soot deposition member to drop off.

Furthermore, as one embodiment, it is desirable that the final peripheral speed is 1.5 m/minute or below in the manufacturing method of quartz glass. According to this, it becomes possible to reduce the rotation speed of the soot deposition member, within a range in which the force exercised onto the soot deposition member at the ending of the deposition process does not exceed the attachment force to the starting member.

### BRIEF DESCRIPTION OF THE DRAWINGS

FIG. 1 a diagram showing a situation prior to manufacturing start, in manufacturing a soot deposition member 5 according to a VAD method.

FIG. 2 is a diagram showing a situation after a predetermined time close to the manufacturing start time, in manufacturing the soot deposition member 5 according to a VAD method.

FIG. 3 is a diagram showing a situation close to the manufacturing ending, in manufacturing the soot deposition member 5 according to a VAD method.

FIG. 4 is a graph showing change in peripheral speed of the starting member 2 for a predetermined time close to the manufacturing start time, in manufacturing a soot deposition member 5 according to a first embodiment example.

FIG. 5 is a graph showing change in peripheral speed of the starting member 2 for a predetermined time close to the manufacturing ending time, in manufacturing a soot deposition member 5 according to a second embodiment example.

### DESCRIPTION OF EXEMPLARY EMBODIMENTS

As follows, an aspect of the present invention is described by embodiments. The following embodiments do not limit the invention that relates to the claims and not all combinations of the features described in the embodiments are necessarily essential to means for solving the problems of the invention.

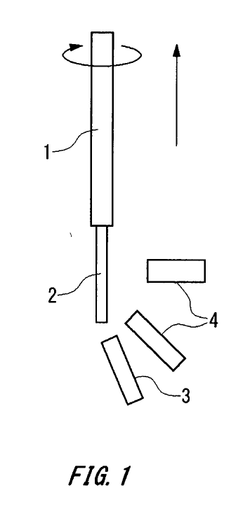

FIG. 1 is a diagram schematically showing a structure of equipment for manufacturing a soot deposition member according to a VAD method. As shown in this drawing, a starting member 2 to which soot is to be attached is mounted to a lower end of a shaft 1 capable of being raised while rotating, as shown by the arrows in the drawing. Additionally in the vicinity of the lower end of the starting member 2, a core deposition burner 3 for depositing soot to be a core portion of an optical fiber base material and a clad deposition burner 4 for generating and depositing soot to be a clad portion are placed. The core deposition burner 3 and the clad deposition burner 4 generate flame that includes soot by being supplied with a raw material gas corresponding to the compositions of soot that they generate respectively, and deposit the soot to the starting member 2 by irradiating the flame to the starting member 2.

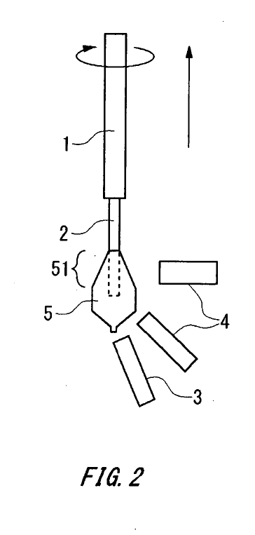

FIG. 2 is a diagram showing an initial situation where the soot deposition member 5 started to be deposited to the starting member 2, in the above equipment. As shown in this drawing, the vicinity of the upper end of the soot deposition member 5 being initially formed is in a tapering form whose outer diameter gradually increases from the thickness of the starting member 2, and takes on a regular outer diameter after a predetermined length has been formed. Among them, an effective portion that has a stable outer diameter is eventually usable as a material of an optical fiber. As opposed to this, the tapering portion in the vicinity of the upper end becomes an ineffective portion 51 that is not used as a material of an optical fiber.

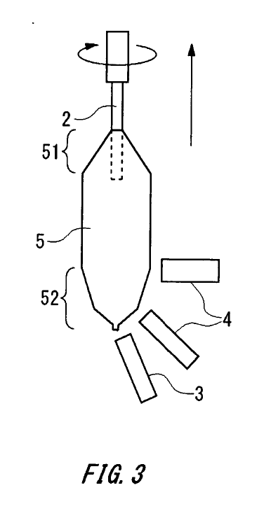

FIG. 3 is a diagram showing a situation close to the ending of the soot deposition process after the soot deposition member 5 of a desired length has been formed in the above-described equipment. As shown in this drawing, as the growth of the soot deposition member 5, the shaft 2 and the soot deposition member 5 rise, whereas a relative position among the lower end of the soot deposition member 5 to which new soot is to be deposited, the core deposition burner 3, and the clad deposition burner 4 is kept unchanged. For this reason, only a portion of the entire length of the starting member 2 has the soot deposition member 5 deposited thereon. In addition, the lower end of the soot deposition member 5 becomes an ineffective portion 52 whose outer diameter gradually decreases from that of the effective portion. Note that the soot deposition member 5 obtained from the series of operation mentioned above is subjected to dehydration, sintering, and vitrification into transparent glass, to be completed as an optical fiber base material that includes a core layer and a clad layer.

As described above, in the manufacturing method of quarts glass according to a VAD method, a tapering portion formed during a predetermined time from the deposition start and a tapering portion formed close to the deposition ending are ineffective portions 51 and 52, neither of which can be used as a material for a product such as an optical fiber. However, this can also be perceived that these ineffective portions 51 and 52 are manufacturable in a different condition from an appropriate deposition condition for a soot deposition member. In view of this, during a period for depositing the ineffective portions 51 and 52, rotation of the starting member 2 and the soot deposition member 5 is slowed down for the purpose of enhancing the attachment force of the soot deposition member 5 to the starting member 2. In depositing the effective portion required as a final quarts glass material, the rotation speed is adjusted so as to yield a predetermined deposition condition. By performing such manipulations, it becomes possible to prevent dropping out of the soot deposition member 5 by improving the attachment force of the soot deposition member 5 to the starting member 2. Furthermore, even when the number of rotation for a predetermined time from the deposition start cannot be sufficiently reduced down, by gradually reducing the number of rotation after the deposition ending, shock in the stopping was reduced and the dropping off attributable to shock was prevented.

Investigation was performed by variously varying the outer diameter of the starting member 2, the number of rotation for a predetermined time from the manufacturing start and a method of reducing the number of rotation after the manufacturing ending. As a result, it was confirmed that as long as the peripheral speed of the surface of the starting member 2 is maintained as 1.5 m/minute or below for a predetermined time from the manufacturing start, the soot deposition member 5 is able to be sintered onto the starting member 2 with sufficient strength, and so hardly drops off. In addition, it is also confirmed that dropping off hardly occurs if, in stopping after deposition ending, the peripheral speed is gradually decreased down to about 1.5 m/minute or below before the rotation stopping in the ratio of the peripheral speed of 1.3 m/minute or below per second, even if the peripheral speed is fast as 2 m/minute or above for a predetermined time after the deposition start.

### EMBODIMENT EXAMPLES

A soot deposition member 5 was manufactured using the equipment shown in FIG. 1-FIG. 3. Note that the equipment used in the following embodiment examples has a control apparatus for changing the rotation of the starting member 2 and of the soot deposition member 5 attached thereto, in accordance with the pre-set schedule. Accordingly, for example, for a predetermined time after the deposition start, the peripheral speed of the starting member 2 is set as 2.0 m/minute or below (preferably 1.5 m/minute or below), thereby enhancing the attachment force of the contact part between the starting member and the soot deposition member. Moreover, after achieving sufficient attachment force, the number of rotation can be increased prior to or concurrently with the deposition of the effective portion, to yield a peripheral speed appropriate for manufacturing the effective portion. Furthermore, after the deposition ending, it is possible to adjust the number rotation so that the peripheral speed of the surface of the starting member 2 is gradually decreased in the ratio of 1.3 m/minute or below per second (preferably 1.0 m/minute or below per second) down to the final peripheral speed, and to finally stop the rotation when it has reached the final peripheral speed.

### Comparison Example 1

Twenty soot deposition members 5 were manufactured in which the mass of a soot deposition member 5 to be deposited to the starting member 2 at the deposition ending time is increased from about 7 kg to about 9 kg, and the number of rotation of the soot deposition member 5 is increased from a conventional 20 rpm to 40 rpm. The starting member 2 employed had an outer diameter of 20 mmφ and a length of 400 mm, and the peripheral speed of the surface of the starting member 2 during manufacturing and at the time of stopping was 2.5 m/minute. The result is that three soot deposition members 5 dropped off from the starting member 2 at the time of stopping the rotation after the soot deposition.

Note that in the above-stated comparison example, each burner 3, 4 is supplied with a raw material gas in the following condition.
Burner 3: O₂/9 slm, H₂/4.5 slm, Ar/1.3 slm, GeCl₄/13 sccm, SiCl₄/300 sccm,
Lower-end burner 4: O₂/15 slm, H₂/16 slm, N₂/2.5 slm, SiCl₄/1.4 slm
Upper-end burner 4: O₂/30 slm, H₂/50 slm, Ar/2 slm, N₂/5 slm, SiCl₄/2.2 slm

### First Embodiment Example

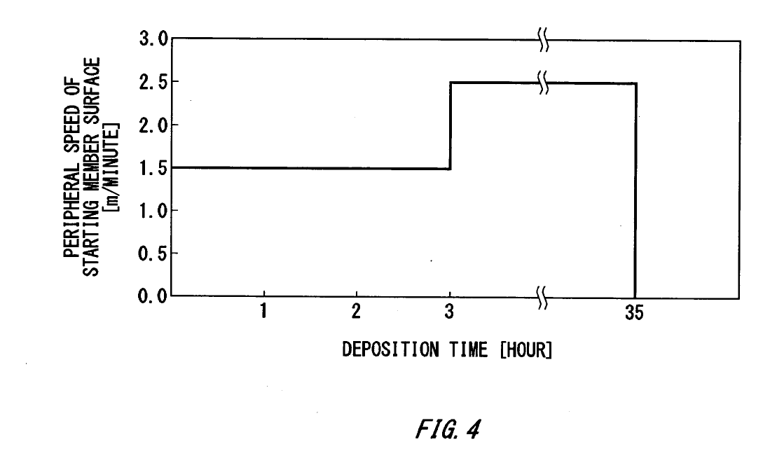

A soot deposition member having about 9 kg of mass at the deposition ending time was manufactured, by employing a starting member 2 that has an outer diameter of 20 mmφ and a length of 400 mm just as in the above-stated comparison example, and at the same condition of each burner 3, 4 as in the above-stated comparison example. This time, as shown in FIG. 4, the number of rotation is kept as 20 rpm (corresponding to peripheral speed of the surface of the starting member 2 of 1.3 m/minute) for three hours from the deposition start and while the ineffective portion is deposited. Later on, the effective portion was manufactured by increasing the number of rotation to 40 rpm. After ending a predetermined amount of deposition, the rotation is instantly stopped. As a result, none of the manufactured fifty pieces dropped off.

### Second Embodiment Example

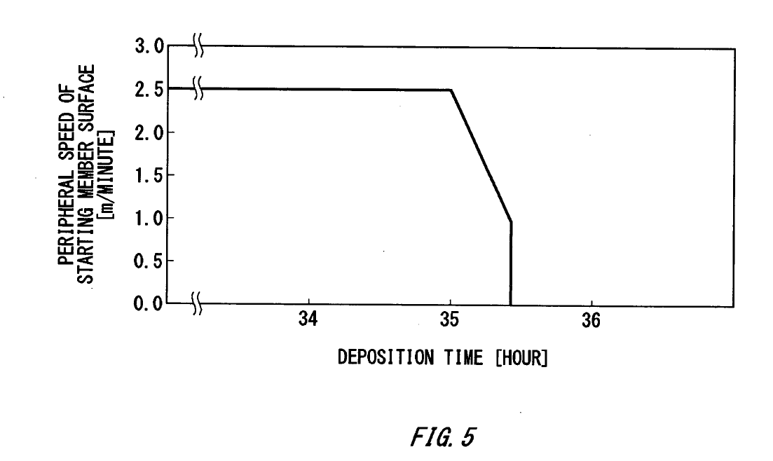

A soot deposition member having about 9 kg of mass at the deposition ending time was manufactured, by employing a starting member that has an outer diameter of 20 mmφ and a length of 400 mm just as in the above-stated comparison example, and at the same condition of each burner 3, 4 as in the above-stated comparison example. At this time, from the deposition start to the middle of deposition, the manufacturing was pursued by maintaining the number of rotation as 40 rpm (corresponding to peripheral speed of the surface of the starting member 2 of 2.5 m/minute). Subsequently, at the deposition ending, the peripheral speed is gradually decreased down to the final peripheral speed of 1.3 m/minute (corresponding to the number of rotation of 20 rpm) in the ratio of 1 m/minute per second, and thereafter the rotation is instantly stopped, as shown in FIG. 5. As a result, none of the manufactured thirty pieces dropped off.

Note that in each of the embodiment examples described above, deposition start in the slow speed rotation and the gradual rotation decrease at the deposition ending were separately performed. However simultaneous performance of both of them enables to better approximate the rotation speed at the deposition start to the level of normal operation. In addition, the rotation speed at the deposition ending is also able to be better approximated to the rotation speed at the normal operation.

To be specific, a soot deposition member was manufactured at the number of rotation at the deposition start of 30 rpm (corresponding to peripheral speed of the surface of the starting member 2 of 1.9 m/minute) and at the number of rotation at the normal operation of 40 rpm (corresponding to peripheral speed of the surface of the starting member 2 of 2.5 m/minute). Moreover at the deposition ending, the peripheral speed of the surface of the starting member 2 was decreased in the ratio of 1 m/minute per second to reach to the final number of rotation of 30 rpm (corresponding to peripheral speed of the surface of the starting member 2 of 1.9 m/minute). Then the rotation was abruptly stopped. Nonetheless, none of the manufactured thirty soot deposition members dropped off at the stopping.

While an aspect of the present invention has been described by way of the above-described embodiment, the technical scope of the invention is not limited to the above described embodiment. It is apparent to persons skilled in the art that various alternations and improvements can be added to the above-described embodiment. It is apparent from the scope of the claims that the embodiment added such alternation or improvements can be included in the technical scope of the invention.

As apparent from the foregoing description, according to one embodiment of the present invention, it is possible to firmly attach a soot deposition member to a starting member, by reducing the initial rotation speed at the starting of soot deposition. In addition, by reducing the change in rotation speed for the soot deposition member close to the deposition ending, it becomes possible to alleviate the force imposed onto the soot deposition member. Accordingly, the soot deposition member is prevented from dropping off or falling off, to lead to stable manufacturing of an optical fiber base material of a high quality.

What is claimed is:

1. A manufacturing method of quartz glass, which includes forming a soot deposition member that includes an effective portion having a substantially constant outer diameter and being to become a material of a glass product and ineffective portions formed at both ends of the effective portion and having an outer diameter changing in a tapering form, by depositing soot to a starting member being raised while rotating, the soot being generated by flame hydrolysis of a raw material gas, the manufacturing method comprising:
an ineffective portion forming step of forming an ineffective portion by setting a peripheral speed of a surface of the starting member to 2.0 m/minute or below, during a time from deposition start of the soot onto the starting member and until the outer diameter of the soot deposition member is stabilized; and
an effective portion forming step of forming the effective portion by rotating the starting member and the soot deposition member at a rotation speed appropriate for forming the effective portion, after the stabilization of the outer diameter of the soot deposition member.

2. The manufacturing method as set forth in claim 1, wherein
in the ineffective portion forming step, the peripheral speed of the surface of the starting member is set as 1.5 m/minute or below.

3. A manufacturing method of quartz glass, which includes forming a soot deposition member that includes an effective portion having a substantially constant outer diameter and being to become a material of a glass product and an ineffective portions formed at both ends of the effective portion and having an outer diameter changing in a tapering form, by depositing soot to a starting member being raised while rotating, the soot being generated by flame hydrolysis of a raw material gas, the manufacturing method comprising:
a forming step of forming an ineffective portion while decreasing a peripheral speed of a surface of the starting member to a predetermined final peripheral speed in a ratio of 1.3 m/minute or below per second during a period after the effective portion is formed and until the starting member and the soot deposition member stop rotating.

4. The manufacturing method as set forth in claim 3, wherein
the final peripheral speed corresponds to the peripheral speed of the surface of the starting member of 1.5 m/minute or below.

5. The manufacturing method as set forth in claim 3, wherein
the ratio in which the peripheral speed of the surface of the starting member is decreased to the predetermined final peripheral speed is 1.0 m/minute or below per second.

6. The manufacturing method as set forth in claim 3, wherein
the peripheral speed of the surface of the starting member is maintained as 2.0 m/minute or below for a predetermined time from deposition start of the soot.

7. The manufacturing method as set forth in claim 3, wherein
the peripheral speed of the surface of the starting member is maintained as 1.5 m/minute or below for a predetermined time from deposition start of the soot.

8. The manufacturing method as set forth in claim 3, wherein
the raw material gas is supplied by means of a burner, and the burner includes a core deposition burner and a clad deposition burner.

9. The manufacturing method as set forth in claim 8, wherein
the raw material gas supplied from the core deposition burner contains O₂, H₂, N₂, Ar, GeCl₄, and SiCl₄.

10. The manufacturing method as set forth in claim 8, wherein
the clad deposition burner includes a lower-end burner and an upper-end burner.

11. The manufacturing method as set forth in claim 10, wherein
the raw material gas supplied from the lower-end burner contains O₂, H₂, N₂, and SiCl₄, whereas the raw material gas supplied from the upper-end burner contains O₂, H₂, N₂, Ar, and SiCl₄.
